(19) United States
(12) Patent Application Publication
(10) Pub. No.: US 2015/0136533 A1
(43) Pub. Date: May 21, 2015

(54) ARRANGEMENT FOR THE FASTENING OF LIFT SHAFT EQUIPMENT TO A WALL IN A MINE SHAFT

(71) Applicant: BERGTEAMET AB, Boliden (SE)

(72) Inventors: Jonas Stenberg, Skelleftea (SE); Gunnar Wallin, Kungalv (SE); Magnus Bergkvist, Boliden (SE)

(21) Appl. No.: 14/401,474

(22) PCT Filed: May 15, 2013
(86) PCT No.: PCT/SE2013/050543

§ 371 Date: Nov. 14, 2014

(30) Foreign Application Priority Data
May 15, 2012 (SE) 1250496-5

(51) Int. Cl. B66B 7/02; B66B 19/00

(52) U.S. Cl. CPC B66B 7/024; B66B 19/00
USPC 187/408

(57) ABSTRACT

The present invention concerns an arrangement for the fastening of lift shaft equipment to a wall in a mine shaft for a personnel lift, the equipment comprising at least one rail that extends in the longitudinal direction of the shaft, on which rail a lift car can run, and fixtures for the mounting of the rail at a predetermined distance from the wall of the shaft. The fixture comprises an extended beam with means that can be adapted to the angular deviation of the wall of the shaft relative to the longitudinal direction of the beam.

The present invention concerns an arrangement for the fastening of equipment for a lift shaft to a wall in a mine shaft for a personnel lift according to the introduction to claim 1.

The term “equipment” is here used to denote the fittings that are mounted in the lift shaft in order for the lift to function, for example guides and rails along which the lift car runs, pipes, electrical lines, and other fittings that are commonly present in lift shafts.

Lifts are used during mining in order to transport personnel up and down in the mine. These lifts are mounted in shafts that are introduced into the rock. The shaft is introduced as vertically as possible, but the vertical direction may vary due to the structure of the rock and other reasons, i.e. a putative line through the rock deviates from a vertical straight line.

The lift cars run along rails that run from the top of the shaft to its bottom. In order for it to be possible for the lift cars to run freely during a long period, it is required that the rails are vertical, even if the longitudinal line of the shaft deviates from the vertical line. In order to achieve this, beams on which the rails are mounted are manufactured. The beams are manufactured according to special order for each location, since the distance from the rail to the wall of the shaft may differ. This leads to high costs and a long installation time for the installation of the lift in the shaft.

The purpose of the present invention is to offer an arrangement with which the rails of the lift can be mounted in a simple, rapid and cost-effective manner, and which arrangement provides the possibility of adjustment of the positions of the fastenings of the rails, even if the longitudinal axis of the shaft deviates from the vertical.

This purpose is achieved with an arrangement that demonstrates the distinctive features and characteristics according to claim 1.

A fastening arrangement according to the invention will be described below with reference to the attached drawings, of which:

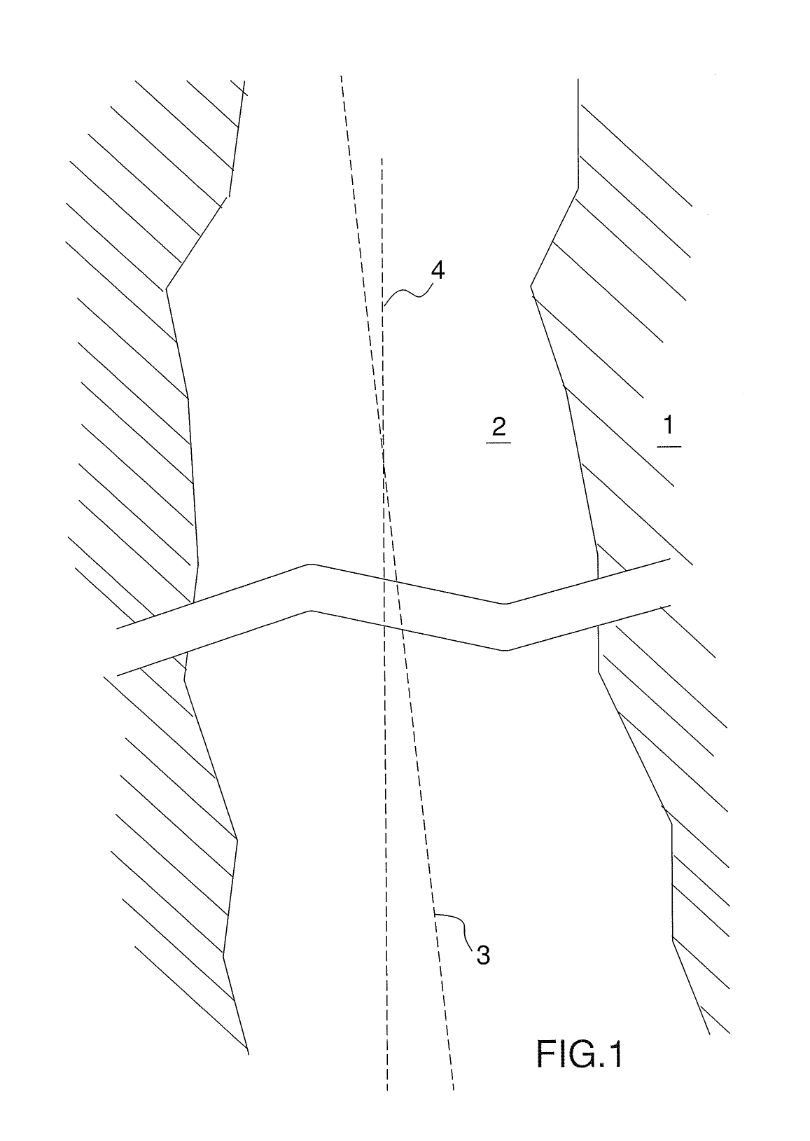

FIG. 1 shows a sectional view of bedrock into which a shaft has been introduced,

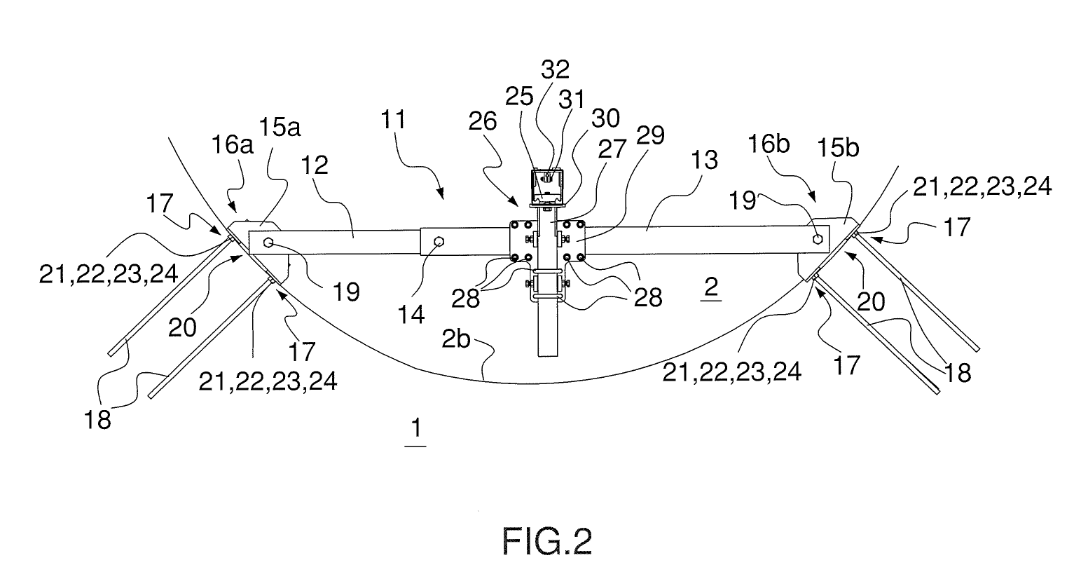

FIG. 2 shows a fastening arrangement according to the invention, on which a lift rail has been mounted,

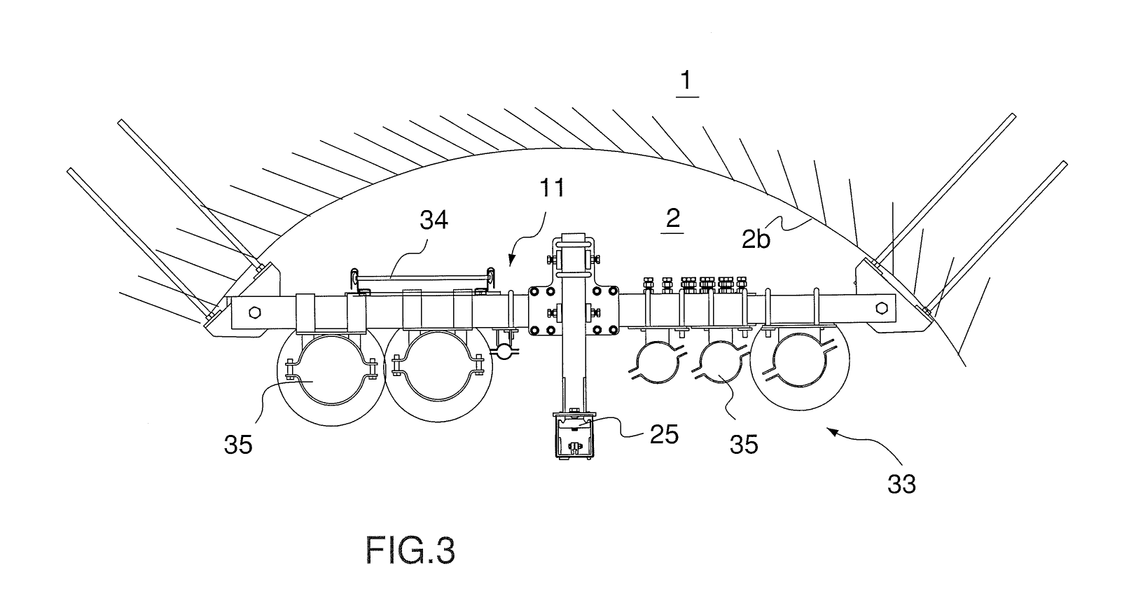

FIG. 3 shows a fastening arrangement according to the invention, on which required accessory equipment has been mounted,

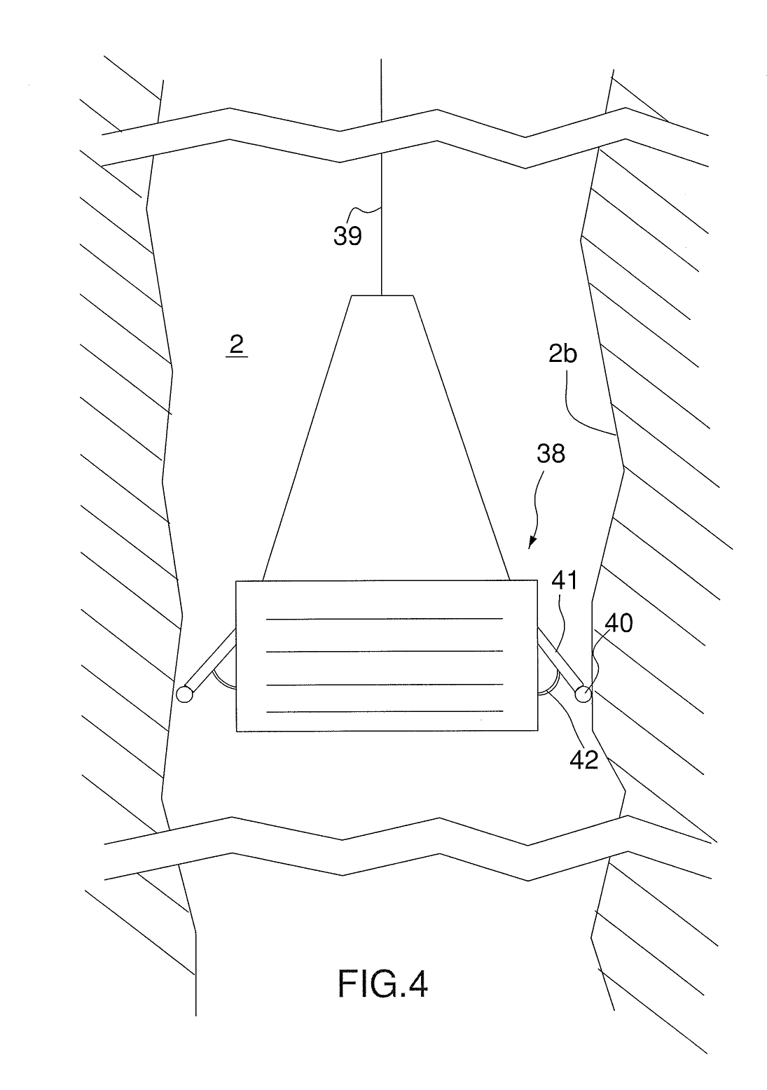

FIG. 4 shows a platform that is used during the mounting of the fastening arrangements, and

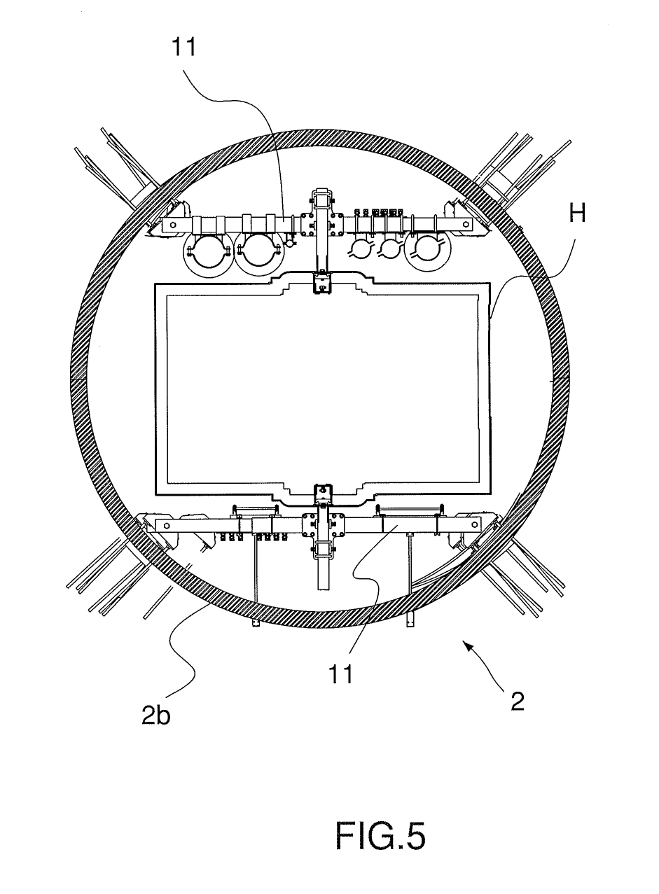

FIG. 5 shows equipment mounted with a lift car in a lift shaft.

A cross-section of bedrock 1 through which a shaft 2 has been introduced is shown in FIG. 1. The length of the shaft may differ, but it is normally several hundred metres. The longitudinal axis 3 of the shaft deviates from a putative vertical line 4, which causes the distances 5 from the longitudinal axis to the walls of the shaft to be different. The difference between the longitudinal axis 3 and the vertical line 4 is measured by, for example, a laser source 6 that can illuminate over long distances, and in this way the vertical line along which it is intended that a lift car H shall run is determined. The laser source 6 may be mounted at the top 7 of the shaft, and may illuminate downwards towards the bottom 8 of the shaft. When a suitable vertical line 4 that gives the lift car H free passage when it has been mounted in the shaft has been determined, the point on the bottom 8 of the shaft from which the line 4 is to originate is marked. This point 9 is used as a reference point in further mounting work. A second laser source is in the same way measured in, in order to make it possible to determine the rotation of the beam relative to the vertical line 4, as will be described below.

When this intended vertical line 4 and the longitudinal direction have been determined, a first fixture 10 is mounted at the bottom of the shaft 2, transverse to the longitudinal direction of the shaft and on its wall 2b. The fixture 10 is located at a distance from the vertical line 4, in order to give the lift car free passage when the lift car is subsequently mounted.

The fixture 10 is designed as a beam 11, as shown in FIG. 2. It comprises two extended beam parts 12, 13, which may advantageously be of square beam type, but it should be realised that also other cross-sections can be used. The advantage of a square cross-section is that the accessory equipment, which will be described below, that is mounted onto the beams can be prevented in a simple manner from swivelling around the beam. The two beam parts 12, 13 have different external dimensions, such that one 12 of the beams can be introduced into the second 13, and in this way achieve a telescopic arrangement. The beam parts 12, 13 are arranged with a lock arrangement 14, in order to provide the possibility of locking the length with which one of the beams has been introduced into the other, and fastening brackets 15a, 15b at their free ends 16a, 16b. The fastening brackets 15a, 15b are provided with several drilled holes 17a-17d, which constitute fastening points for pin bolts 18. The fastening brackets, furthermore, can be rotated around an axis 19 that is parallel to the vertical line 4 of the shaft when the beam 11 has been mounted. It is an advantage if the axis 19 of rotation is located between the fastening points 17 in order to avoid a leverage effect from the beam 11 when it has been screwed fast in the wall of the shaft. It is an advantage if the axis 19 of rotation comprises a bolt with a nut that can be tightened and secured when the beam has been mounted. The contact surfaces 20a, 20b of the fastening brackets that are intended to face towards the wall of the shaft are essentially parallel to the axis 19 of rotation. It should be realised that the number of drilled holes in the fastening brackets and the number of pin bolts that are fastened into the wall of the shaft can be increased in order to further stabilise the fastening of the beam.

The first beam, also known as the “bottom beam”, is mounted in the following manner: a drilling template (not shown in the drawings) that is arranged with marked points is placed at a position at which the laser beams and the marked points coincide. When the template is in the correct position, marks are made showing where the holes in the wall 2b of the shaft are to be drilled. The drilling template is removed when the holes have been marked on the wall 2b of the shaft on both sides of the laser beams. Holes for pin bolts 18 are subsequently drilled in the wall 2b of the shaft. When the holes have been drilled, the pin bolts are embedded in, for example, concrete or glue, in the holes. It should be realised that another type of fastening, such as expansion bolts, can be used. When the embedding medium has hardened, a counteracting nut 21 is screwed onto each of the pin bolts 18, and it is an advantage if a washer 22 is placed against the nut 21. The beam 11 is subsequently pressed together, i.e. the length of the beam is shortened in order to avoid it impacting the wall 2b of the shaft or other objects that may be present in the wall. The beam 11 is lifted, advantageously with the aid of a lifting hook or similar, to the level at which the pin bolts 18 have been embedded.

The drilled holes 17a, 17b of one of the fastening brackets 15a are subsequently adjusted for the pin bolts 18, and manoeuvred in the direction towards the wall into which the pin bolts 18 have been fastened, to the position at which the fastening bracket 15a comes into contact with the washers 22 at the counteracting nuts 21. One washer 23 and one nut 24 are mounted onto each pin bolt 18 and screwed fast, whereby one fastening bracket 15a is now in place. The beam 11 is subsequently extended through the beam part 13 that is not screwed fast at its fastening bracket 15b being drawn out from the beam part 12 that has been screwed fast. The second fastening bracket 15b is positioned in a corresponding manner, with the pin bolts 18 passing through the holes 17c, 17d in the fastening bracket 15b and making contact with the washers 22 of the counteracting nuts 21, and screwed fast. With the beam 11 in place, the location and the angle of the beam 11 relative to the vertical line 4 can be adjusted with the aid of the counteracting nuts 21, after which all nuts 24 are tightened to a predetermined value of torque. In order to improve the stability, the lock arrangement 14 of the beams is screwed fast in order to further prevent the two parts 12, 13 of the beam being able to move relative to each other.

It is an advantage if the positions of all of the beams and their drilled holes are marked along the complete length of the shaft, after the first beam, i.e. the bottom beam, has been mounted. The drilling template is displaced a predetermined length along the shaft, for example 3 metres, and the locations at which holes are to be drilled are marked at each position. This can be carried out by drilling a guide mark for each drilled hole with the aid of a hand-held drill, or by a permanent marking in another manner, for example using paint. The distance by which the drilling template is to be displaced is measured with the aid of, for example, a long measuring tape that has been fastened to the first beam. All holes are subsequently drilled, and pin bolts are embedded fast in the drilled holes.

The beams are so mounted in a corresponding manner at each position at which the pin bolts have been embedded along the length of the shaft. It is an advantage if the beams are located in pairs at each position, facing each other in such a manner that a lift car can run along the shaft between the beams, as is shown in FIG. 5. It is an advantage if the laser sources are mounted at the top of the shaft, while the beams are mounted from the bottom upwards. This gives the advantage that the laser beams pass each mounting position freely. The laser beams constitute the guide point for each beam, which results in all beams being in a vertical line, aligned with each other, when all beams have been mounted and adjusted.

The rails 25 of the lift can be mounted when all beams have been mounted according to the method specified above. The rails 25 are arranged in sections with lengths that correspond to the distance between a number of beams: in this embodiment they are 12 metres long, and thus extend between five beams. A bracket 26 is placed at the end of each section of rail, which bracket is screwed fast into the rail. The bracket 26 comprises an angular bracket 27 that is screwed fast in connection with the centre of the beam 11 with the aid of yokes 28 around the beam. The angular bracket 27 comprises two parts, one of these is a mounting plate 29 for the mounting on the beam with the aid of the yokes, the other is a support plate 30 that, when the bracket 26 is screwed fast to the beam 11, runs parallel to the vertical line 4 and the rail 25. The yokes 28 enable the rail 25 to be adjusted in the sideways direction along the length of the beam 11. It is possible also to adjust the two parts 29, 30 of the angular bracket 27 relative to each other with the aid of adjustment screws at the mounting plate 29 that can influence the angle of the support plate 30 relative to the direction of the beam 11 and the distance between the support plate 30 and the beam 11. These possibilities of adjustment make it possible to adjust the rails to a position at which the lift car can run.

It is an advantage if the rails 25 are joined in connection with a bracket 26, but if the rails must be joined at a position at which no bracket is located a joining element 31 is used. The joining element 31 is designed as an extended clamp that clamps a flange 32 that is present on the rail and that holds that rails together with each other.

Also accessory equipment, for example cable runs 34 for the mounting of cables for the feed of power to the lift, and water lines 35, can be mounted at the beams 11, as is shown in FIG. 3. This accessory equipment is fastened to the beams in the same way, using brackets 36 and yokes 37.

In order to further reinforce the fastening of the fastening brackets 15a, 15b to the wall of the shaft, a moulding form can be built up around each fastening, after which the complete fastening behind the fastening brackets is embedded. This gives improved stability, prevents the nuts 21, 24 being turned, and gives also improved protection against corrosion, which is a common occurrence in the environment that a mine shaft implies.

A personnel platform 38 may be lowered into the shaft, as shown in FIG. 4, in order to facilitate the mounting. The platform is suspended from a wire 39 from a hanging stage (not shown in the drawings) or other type of hoist, and it is loaded with a number of beams before being lowered to the bottom of the shaft together with the mounting personnel. The platform may be so designed that the laser beams described above pass freely, i.e. they can pass through the platform without deviation. This is advantageous if it becomes necessary to check the positions of the laser sources. It is an advantage if the platform is provided with guides in the form of running wheels 40 mounted on arms 41 that extend from the sides of the platform and that can run against the wall 2b of the shaft. The arms are arranged with spring means 42 that act between the platform and the arms. The running wheels come into contact with the walls of the shaft with the aid of the spring means 42 in such a manner that the platform is always located in, or in the vicinity of, the centre of the shaft.

The present invention is not limited to what has been described above and shown in the drawings: it can be changed and modified in several different ways within the scope of the innovative concept defined by the attached patent claims. Other alignment means than laser sources, such as plumb lines, may, for example, be used.

1. An arrangement for the fastening of lift shaft equipment to a wall in a mine shaft for a personnel lift, the equipment comprising at least one rail that extends in the longitudinal direction of the shaft, on which rail a lift car (H) can run, and fixtures for the mounting of the rail at a predetermined distance from the wall of the shaft, characterised in that the fixture comprises an extended beam that is telescopic and that comprises two tubular parts one placed inside of the other, one of which is placed inside the other in a manner that allows it to be displaced, and means arranged at the ends of the beams for the fastening of the beam into the wall of the shaft.

2. The arrangement according to claim 1, whereby it comprises locking means for locking the relative displacement of the two parts.

3. The arrangement according to claim 1, whereby the means comprise brackets that are attached at the free ends of the beam in a manner that allows rotation.

4. The arrangement according to claim 3, whereby the brackets demonstrate fastening points for their fastening into the wall of the shaft and are fastened in a manner that allows rotation around an axis of rotation that is parallel to the longitudinal direction of the shaft.

5. The arrangement according to claim 4, whereby the axis is located between two fastening points.

6. The arrangement according to claim 4, whereby the attachment points comprise drilled holes for pin bolts embedded into the wall of the shaft.

7. The arrangement according to claim 1, whereby the rail comprises a bracket that is fastened to the beam in a manner that allows it to be displaced.

8. The arrangement according to claim 7, whereby the bracket comprises means for the adjustment of the distance of the bracket and its angle relative to the beam.

9. The arrangement according to claim 7, whereby the bracket comprises a support part to which the rail is fastened.

10. The arrangement according to claim 1, whereby the beam comprises brackets and yokes for the fastening of water lines that extend in the longitudinal direction for the shaft.

11. The arrangement according to claim 1, whereby the beam comprises brackets and yokes for the fastening of a cable run that extends in the longitudinal direction of the shaft.
